(19) United States
(12) Patent Application Publication
(10) Pub. No.: US 2011/0203560 A1
(43) Pub. Date: Aug. 25, 2011

(54) FUEL CONDITIONING VACUUM MODULE

(76) Inventor: William K. Wallace, Victoria (CA)

(21) Appl. No.: 12/710,986

(22) Filed: Feb. 23, 2010

(51) Int. Cl. F02M 29/00; F02M 29/04

(52) U.S. Cl. 123/590

(57) ABSTRACT

A module for an internal combustion engine and particularly to a fuel conditioning vacuum module for an internal combustion engine having a plurality of plates disposed within the module to define a passageway between an inlet and outlet so as to permit the fuel from the fuel-air mixing device to change from a liquid to a substantially gaseous state in the fuel-air mixture when communicating with at least one cylinder of the internal combustion engine. This invention also relates to a method of changing the state of liquid fuel to a gas when a liquid fuel is introduced into a fuel-air mixing device in an internal combustion engine.

### FIELD OF INVENTION

This invention relates to a module for an internal combustion engine and particularly to a fuel conditioning vacuum module for an internal combustion engine having a plurality of plates disposed within the module to define a passageway between an inlet and outlet so as to permit the fuel from the fuel-air mixing device to change from a liquid to a substantially gaseous state in the fuel-air mixture when communicating with at least one cylinder of the internal combustion engine. This invention also relates to a method of changing the state of liquid fuel to a gas when a liquid fuel is introduced into a fuel-air mixing device in an internal combustion engine.

### A BACKGROUND TO THE INVENTION

Although many improvements have been proposed over the years for the basic internal combustion engine, it has remained the case that the fuel namely the gasoline supplied into the cylinder or cylinders of the internal combustion engine has been a wet saturated fuel. For example, in carburetor engines and throttle body fuel injection engines, liquid fuel is drawn or pumped into an air stream in the throat of the fuel-air mixing device, such as a carburetor or injector, in order to create a fuel-air mixture. This fuel-air mixture is fed directly into the intake manifold and in turn into the individual cylinders of the internal combustion engine. In a multi-port fuel injection engine, liquid fuel is sprayed into the cylinders in an atomized form by the fuel injectors. Accordingly, the fuel-air mixture entering the cylinders in prior art internal combustion engines has been a mixture of air and wet saturated fuel. In other words the fuel, i.e. gasoline has been introduced as an atomized form.

Generally speaking, wet saturated fuel does not completely burn. Rather, the wet saturated fuel must be prepared for burning by being vaporized or gasified. In the prior art internal combustion engines, this vaporization of the liquid fuel has occurred in the cylinder due to the heat of compression and combustion.

Therefore a vaporized fuel-air mixture is a “wet-saturated” fuel-air mixture where the gasoline is initially introduced as droplets of liquid fuel. Therefore vaporization is different from gasification where gasification comprises a change of state from a liquid to a gaseous form. In other words the gasoline changes its state from a liquid to a gas which comprises of molecules interacting with the molecules of air.

This distinction has not generally been appreciated in the prior art.

The term “change of state” is different from “wet-saturated”. Generally speaking, atoms or molecules that make up all matter change their basic “nature” in relation to one another when a “change of state” occurs. Generally speaking, in solids the atoms or molecules adhere to one another with a powerful force called “cohesion”. When heat is added to most solid matter (“except with ice”) the atoms or molecules respond by expanding with increased speed of the electrons that form the shell around the proton-nucleus. During this activity, the action of cohesion changes to one of passivity as in liquids. With a change of state, the liquid can expand when heat is applied, or contract when cool. This is the change of state from a solid to liquid for most molecules. When more heat is added to the liquid the heat is called “latent heat of fusion”. In this case, the atoms or molecules now speed up and the nature of the very same atoms or molecules change to repulsion where the powerful force of repulsion provides the nature and the basis of all gases. Accordingly all atoms or molecules in a gas repel each other. Generally speaking it is this gaseous state that makes gases extremely flammable when compared to their liquid state; as the combustion process can now propagate throughout the entire gas envelope and pass from atom to atom or molecule to molecule substantially instantaneously.

Accordingly all atoms or molecules in a gas are separate, not bound by forces that inhibit the spread of combustion from atom to atom or molecule to molecule. The flammable mixture in a gaseous state is explosive when compared to its liquid state. This is what drives the piston in the engine cylinder in an internal combustion engine.

Therefore a gaseous state is different from vaporizing a fuel where the vapour is comprised of millions of droplets of “liquid in suspension”. When the liquid in suspension is suspended in air the fuel droplets are not completely burnable by themselves no matter how small they are in microns.

Many prior art devices such as an injector or carburetor introduce a wet-saturated vapour into the intake manifold of an internal combustion engine where complete combustion is not possible to be achieved in hundredths of a second, because the flame front must spread to all the droplets and where only the outer droplet sphere surface can rapidly gasify to sustain the combustion. Therefore complete combustion is impossible. This is why catalytic converters are used in the prior art to complete the combustion that was not completed in the cylinder. Furthermore, in today's automobile the combustion stroke is too short and not enough time is given in a cylinder for complete combustion.

Many prior art devices work on the premise than on the compression stroke the heat of compression and the pressure of compression forces the droplets closer together and creates the heat necessary to combust the fuel droplets after ignition by electrical spark. To get enough energy to produce usable power, surplus droplets are required as in the stoiciometeric mixture of 14 parts air to 1 part fuel (used in most four cycle gasoline engines). Incomplete combustion occurs when surplus fuel is used, resulting in unburned hydrocarbons as pollution.

With the invention to be described herein substantially all of the fuel is gasified, i.e., changed from a state of liquid droplets to gaseous molecules, resulting in a more complete combustion.

There have been many attempts in the past to improve the performance and efficiency of internal combustion engines such as those as shown and taught in U.S. Pat. No. 4,470,198, U.S. Pat. No. 4,200,070, as well as U.S. Pat. Nos. 5,046,475, 4,355,623; 4,770,151, 4,300,513, 4,286,564, 4,137,875, and U.S. Pat. No. 5,040,518.

More promising improvements have been disclosed in U.S. Pat. No. 5,606,956 which teaches an elongated fuel-air bypass for an internal combustion engine as well as U.S. Pat. No. 5,769,059 again relating to an elongated fuel-air system for an internal combustion engine.

Other arrangements are shown in U.S. Pat. No. 5,782,225 which relates to a fluid vaporization system comprising a first fluid inlet for receiving a first fluid, a second fluid inlet for receiving a second fluid, and a first discharge aperture for discharging the first fluid and the second fluid. A first connecting passage connects the first fluid inlet and the second fluid inlet and fluid communication with the first discharge aperture, mixes the first fluid and the second fluid to define a fluid mixture, and delivers the fluid mixture to the first discharge aperture. A third fluid inlet receives a third fluid and a second discharge aperture discharges the third fluid.

U.S. Pat. No. 6,508,236 relates to atomizing air flowing in an atomizing gas passage which is merged with the fuel spray to promote atomization of the fuel, the carrier air following in a carrier gas passage is merged with the fuel spray at a further downstream position so as to surround the fuel spray. By doing so the atomized fuel spray is carried to the downstream side so as to prevent the fuel spray from adhering on to the wall surface.

Another arrangement is shown in U.S. Pat. No. 6,606,976 which teaches a fuel supply system for use in an internal combustion engine, comprising an intake passage; a downstream fuel injection valve near the port of each cylinder of the engine and downstream of the intake passage; and a controller, wherein the intake passage includes a fuel injection/evaporization device which has an upstream fuel injection valve; a heater for evaporating injected fuel, and an air passage for supplying the injection fuel with air.

Moreover U.S. has published application number 2003/0183209 relates to a fuel delivery system which includes an injector having an end region. The end region is provided with heat conducting material such as metal so that the end region can be heated by exhaust gas to heat the temperature of fuel in the injection end region so that the increase in temperature and pressure within the end region causes the fuel to flash into a vapour state immediately, the fuel is ejected from the injector. The exhaust gas is supplied by an exhaust gas supply line and can be returned by an exhaust return line.

Moreover U.S. Pat. No. 6,990,966 relates to a heater unit for a combustion stabilizing device in a combustion stabilizing device including the same.

Since the prior art generally focuses on vaporization of a gasoline, namely the suspension of liquid gasoline in air, there is generally incomplete combustion which adds to air pollution. Air pollution due to hydrocarbon and carbon monoxide emissions of internal combustion engines is becoming an increasing concern, especially in metropolitan areas. The major attempts thus far to reduce emissions have been by using lean burn engines and by providing air-cleaning devices, such as the catalytic converter, downstream of the engine to burn up the unburned hydro carbons and carbon monoxide gas. Although these innovations have proven somewhat successful, the ability to reduce emissions in this manner is limited.

Another problem that is exhibited by prior art devices relates to wall wetting. Wall wetting is a result of some of the liquid droplets that are in suspension to condense on the cylinder walls of a four stroke engine. This can cause the cylinder walls to be cooled to radiator temperatures which can be in the vicinity of 213-214 degrees Fahrenheit. This temperature is well below the temperature that gasoline will quickly boil or change state into a gas. Combustion temperatures are generally 1800 degrees Fahrenheit and up. Inside the cylinder all liquid gasoline droplets and vapours will generally migrate to the coolest surface, namely the surface of the cylinder walls. If the temperature is low enough the droplets will condense and they will wet that surface, and again liquid gasoline will not generally burn as described above. A portion of the liquid droplets in the suspension with the cylinder will condense onto the cylinder walls, where it will remain as liquid until the piston rings scrape them off. This fuel that is still in the liquid form cannot burn and is consequently pushed into the exhaust stream by the piston as fuel that is not burnt and contributes to exhaust pollution. Pressure and temperature basically determine the condition that wall wetting will take place. Generally speaking the use of the invention to be described herein greatly reduces the possibility of wall wetting, and thus reduces the prospect of incomplete combustion, and reduces pollution.

Mild heat, time and distance is provided inside the vacuum module to be described herein so as to permit the change of state from the gasoline module from a liquid to a gas. Accordingly before the fuel mixture enters the cylinder it has gone through the change of state to become a gas, mixed with the gas of the air and therefore there is little or no liquid droplets or vapours in the fuel-air mixture. Accordingly combustion is more complete at generally most RPMs.

It is an aspect of this invention to provide a module for an internal combustion engine having: an inlet communicating with a fuel-air mixing device; an outlet communicating with an intake manifold; a passageway communicating with the inlet and outlet for permitting the fuel to substantially change from a liquid to a gaseous state when mixed with the air.

Another aspect of this invention relates to a fuel conditioning vacuum module for an internal combustion engine having a fuel-air mixing device and an intake manifold communicating with at least one cylinder, said module comprising: an input communicating with the fuel-air mixing device; an outlet communicating with the intake manifold; a plurality of plates disposed within the module to define a passageway between the inlet and outlet to permit the fuel from the fuel-air mixing device to change to a substantially gaseous state in the fuel-air mixture when communicating with the at least one cylinder.

Yet another aspect of the invention relates to A method of changing the state of liquid fuel to a gas when the liquid fuel is introduced into a fuel-air mixing device in an internal combustion engine communicating with at least one cylinder comprising the steps of: disposing a thermally conductive module between the fuel-air mixing device and the cylinder; the module having an inlet and an outlet communicating with a passageway there between; extending the passageway through a length in the module to permit mixing of the fuel in a substantially gaseous state with the air.

These and other features and objects of the invention should now be described in relation to the following drawings.

### DESCRIPTION OF THE DRAWINGS

FIG. 1 is a representative view of an internal combustion engine in an automobile utilizing the invention herein.

FIG. 2 is a perspective view of the invention.

FIG. 3 is a cross-sectional view of the module.

FIG. 4 is a top plan view of another embodiment of the invention.

FIG. 5 is a cross-sectional view taken along the line 5-5 of FIG. 4.

FIG. 6 is a cross-sectional view taken along the line 6-6 of FIG. 4.

FIGS. 7a and 7b relate to chart inspection reports showing the advantages of the invention described herein. In particular FIG. 7a shows a gas emission test for a 1977 Dodge without a catalytic converter with a carburetor and FIG. 7b shows a gas emission test for a 1977 Dodge without a catalytic converter with a module disposed between the carburetor and intake manifold.

### DESCRIPTION OF THE INVENTION

Various embodiments and features of the fuel-air module according to the present invention will now be described in detail with reference to the drawings. It is to be noted that various embodiments of the overall invention are shown and described and at various embodiments of the individual features of the invention are shown and described. It is contemplated various alternate embodiments of the individual features can be used in various combinations including combinations now particularly described and shown. It is further contemplated that the module of the present invention will be useful as original equipment in automobiles, as well as in the form of retrofit kits for improving an internal combustion engine subsequent to original manufacture.

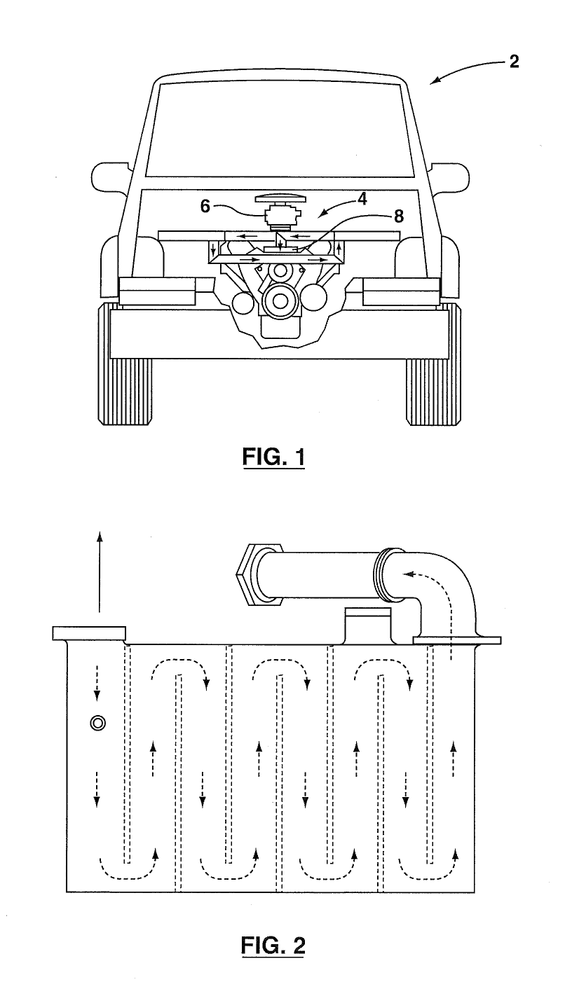

FIG. 1 illustrates the invention in relation to an automobile 2 having an internal combustion engine 4 with a fuel-air mixing device 6 that can comprise either a single point fuel injector or carburetor 6 and intake manifold 8 which communicates with at least one cylinder (not shown).

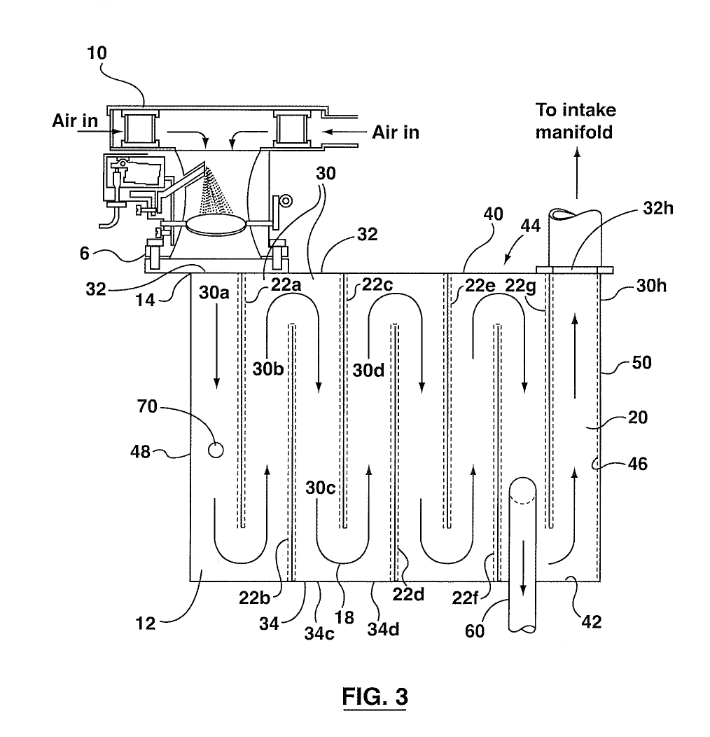

A more detailed view of the invention is illustrated in FIGS. 2 and 3 which shows an air filter 10 and a fuel conditioning vacuum module 12. The module 12 has an inlet 14 communicating with the fuel-air mixing device 6 and an outlet 16 communicating with the intake manifold 8. The module 12 also includes a passageway 18 communicating with the inlet 14 and the outlet 16 for permitting the fuel to substantially change from a liquid to a gaseous state when mixed with the air.

The module 12 includes passageway lengthening means 20 which in one embodiment as shown comprises a partition means 20. The partition means in one embodiment can comprise of a plurality of plates 22a, 22b, 22c, 22d, 22e, 22f and 22g. In other words, by utilizing the plates 22 the passageway 18 becomes a circuitous or serpentine path around the plates so that the length of the passageway is longer than the distance between the input 14 and the output 16. In other words, the module 12 provides sufficient distance and time inside the vacuum module 12 so as to cause the change of state of the gasoline molecules from a liquid to a gaseous state.

Since the module 12 is under a vacuum the plates 22 also rigidify the module and prevent it from collapsing in view of the vacuum created by the engine components. The arrangement shown in FIG. 2 presents a serpentine passageway 18 between the inlet 14 and outlet 16.

Furthermore the module 12 as well as the plates 22 are comprised of a thermal conductive material which can comprise of any material including that of aluminum, steel and copper. Sufficient heat is generated by the operating engine which is conducted by the conductive material of the module 12 so as to heat up and thereby assist in the changing of state from the gasoline liquid droplets to that of a gaseous state.

Thermal protection for very cold climates applications is made easy by the compact design of the module. A high temperature thermal blanket can be sprayed on the module for cold climate conditions.

The module 12 can comprise in one embodiment a rectangular device having a top wall 40 and a bottom wall 42 with spaced sidewalls 44 and 46 and spaced end walls 48 and 50. The plates 22a, 22c, 22e, and 22g, extend from the top wall 40 between the side walls 44 and 46 and the end walls 48 and 50 as shown; but do not extend to but are spaced from the bottom wall 42. Moreover plates 22b, 22d, 22f, extend from the bottom wall 42 between the side walls 44 and 46 and end walls 48 and 50 as shown; but do not extend to but are spaced from the top wall 44 as shown. Accordingly the plates within the module 12 provide a serpentine passageway 18.

Moreover in the embodiment shown in FIG. 2 the module 12 is comprised of a plurality of substantially parallel conduits 30a, 30b, 30c, 30d, 30e, 30f, 30g, and 30h, each having one end 32a, 32b, 32c, 32d, 32f, 32g, 32h, and another end 34a, 34b, 34c, 34d, 34e, 34f, 34g, and 34h as shown.

One end 32a of conduit 30a defines the inlet 14 and one end 32h of another conduit 30h finds the outlet 16.

The other plurality of conduits have adjacent one ends 32b, 32c, 32d, 32e, 32f, 32h, and another end 34a, 34b, 34c, 34d, 34e, 34f, 34g and 34h, communicating with one another to define the passageway 12. For example, conduits 30b, and 30c, have one end 32b, and 32c, which are adjacent to one another and communicate therethrough. The other end 34c and 34d, of conduits 30c, and 30d, also communicate with one another. Furthermore the plurality of conduits 30 are disposed along the common plane so as to define a genuinely rectangular module.

Accordingly the plurality of conduits 30 or plates 22 define a passageway which is sufficiently long in length so as to permit the gasoline to change state from a liquid to a gaseous state. In other words the length of the passageway 18 is longer than the distance between the inlet 14 and the outlet 16.

The material of the plates, conduits and module 12 comprises a thermal conducting material which can be selected from a group of aluminum, steel and copper. A thermal conductive material also assists in absorbing ambient heat from the engine so as to assist in changing the state of the gasoline vapour from a liquid to a gaseous state as described. Heat is generally supplied to the module 12 from the ambient temperature under the hood, or conducted through the engine.

Moreover since the outlet 16 of the module 12 is connected to the intake manifold sufficient vacuum is generated by the engine components so as to draw the mixed fuel and air through the air filter 10, the fuel-air mixing device 6 and the module 12.

The module 12 also includes a pressure relief valve 60.

The module also includes a secondary air input 70, which can be used to modify the primary stoichimetric fuel to air rotation supplied by the carborator. The secondary air input 70 in one embodiment is placed behind the primary air throttle to “lean down” the stoichimetric fuel air ratio and to reduce combustion temperature and control NOX emissions in accordance with proven hydrogen powered applications for IC engines. The ability of the module 12 to “lean down” the stoichimetric fuel ratio makes it possible to increase the compression ratio for greater efficiency as shown on hydrogen powered engines. For example some automobiles operate at a compression ratio of 9-1. By utilizing the invention described herein it is possible that the compression ratio for the new gasified powered IC can be increased to 12.5 to 14 to 1; which represents an enormous increase in power. Also EGR can be used directly into the intake as another way to help control NOX.

In one embodiment the on board computer (not shown) will control the primary air to fuel ratios supplied by the fuel-air mixing device 6 and will also control the secondary make up air to respond to changing load conditions when extra air is needed for leaner mixtures. The computer will be connected to sensors that will sense the fuel-air ratio and provide a feedback to activate input 70.

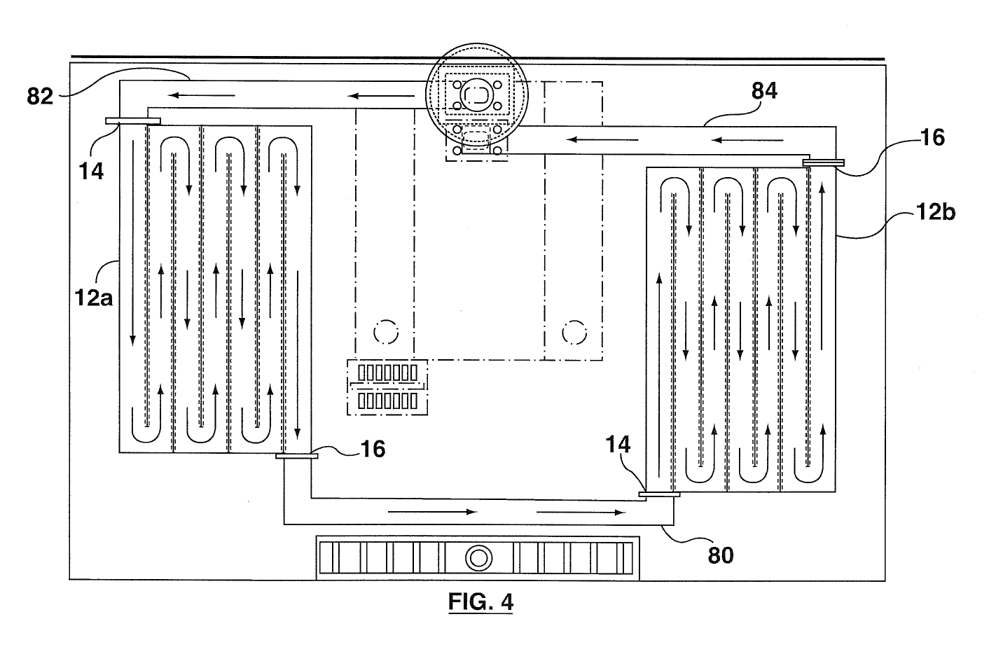

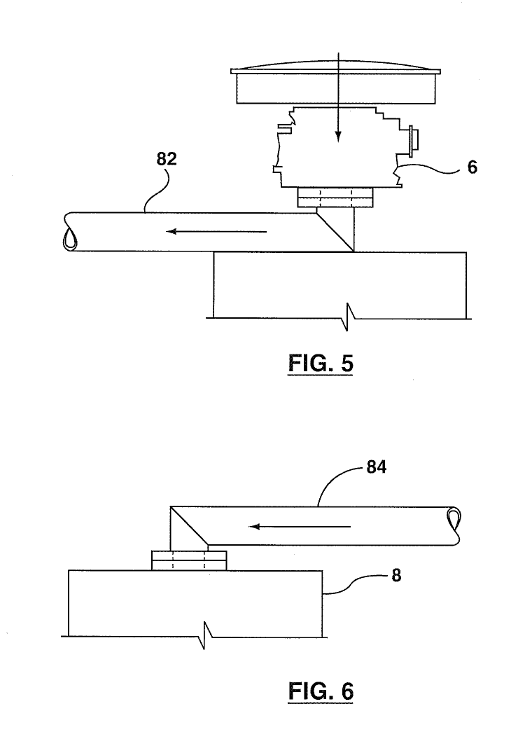

FIG. 4 illustrates another embodiment of the invention which shows that the module 12 can comprise of two modules 12a and 12b connected together by connectors 80. Connector 82 connects the fuel-air mixing device 6 to input 14 of module 12a. The output 16 of module 12 is connected to connector 80. Connector 80 is connected to the input 14 of module 12b, which the out put 16 of module 12b is connected to connector 84, also connected to the intake manifold 80.

The module 12 can be configured to fit any space locked under a hood (not shown) of an automobile. Alternatively the module 12 can be incorporated into the frame, chassi, or metal area of an automobile.

Moreover the invention herein can be used for any internal combustion engine such as, in lawn mowers and the like.

The invention described herein also relates to a method of changing the state of liquid fuel to a gas when the liquid fuel is introduced into a fuel-air mixing device 6 in an internal combustion engine 4 communicating with at least one cylinder which comprises the steps of:
disposing a thermally conductive module 12 between the fuel-air mixing device 6 and at least one cylinder, the module having an inlet 14 and an outlet 16 communicating with the passageway there between; extending the passageway through a length in the module to permit mixing of the fuel in a substantially gaseous state with the air.

The passageway length is greater than the length between the inlet and outlet and the passageway is serpentine in structure. The greater the distance from the throttle (within reason) to the intake manifold the greater the effectiveness of the gasification process. The serpentine fuel air passage inside the module 12 must be large enough for sufficient natural aspiration when used in regular passenger automotive applications.

The invention described herein permits much leaner stoiciometeric ratios of air to gasoline in the range of 14:1 and 17:1, resulting in fuel savings, less pollution, and greater efficiency.

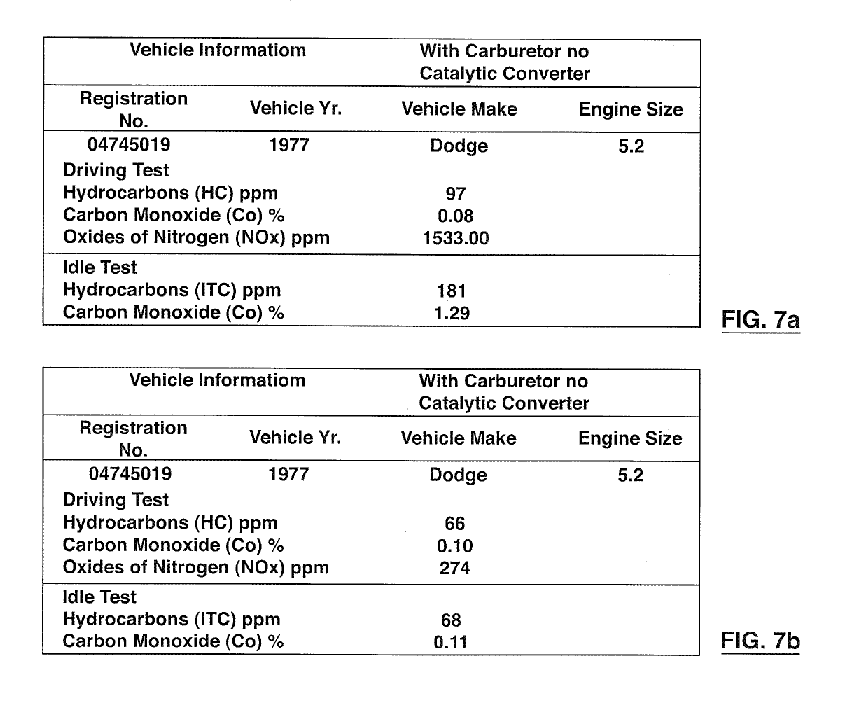

Furthermore FIGS. 7 a and 7b show the improvement relating to fuel consumption, and carbon dioxide emissions hydrocarbon emissions and NOX emissions which are realized by utilizing the invention described herein. One can see the dramatic improvement and performance of the automotive engine with only a carburetor (no module nor catalytic converter) and with the module 12 described without a catalytic converter. As can be seen in FIGS. 7a and 7b by inserting the module 12 the hydrocarbons dropped from 97 ppm to 66 ppm in the driving test and dropped from 1533 ppm NOX to 274 ppm in the driving test. Moreover during the driving test the CO changed from 0.08 to 0.10 which is roughly constant given the testing margin of error. Also during the driving test the RPM was sufficiently high so one would not expect much of a change in CO as sufficient oxygen would be present and CO generally develops where there is an insufficient supply of oxygen. During the idle test the hydrocarbons dropped from 181 ppm to 68 ppm and CO from 1.29 to 0.11 ppm.

With prior art vaporization, liquid droplets of gasoline are suspended in the air. On the compression stroke the pressure forces the droplets closer together, and this creates the heat required to combust the fuel droplets after ignition by electric spark. To get enough energy to produce useable power, surplus droplets are required in the stoichiometric mixture of approximately 14 parts air to 1 part fuel, generally used in all 4 cycle gasoline engines. All engines tested as described above at idle required much less fuel after the addition of the module 12 as compared to no module to produce the same idle. Moreover the idle RPM in the example referred to above tripled when changed from a wet saturated stoiciometric fuel air mixture to the invention described herein.

The stoichiometric ratio of 14 parts air to 1 part fuel is generally needed and necessary for wet saturated vapour mixture, but it is too rich for this invention for the same amount of power developed. Therefore a leaner mixture of fuel to air is possible, more power, better mileage, through more complete combustion.

The invention described herein can be used as an instant start. When the engine is shut down, the cylinder next to fire is already charged with the fuel air mixture. When a spark is supplied, it will ignite the fuel in the cylinder causing the engine to automatically start running. This can be accomplished by sending an ignition spark selectively to that cylinder, or by sending a spark to all cylinders simultaneously. If, for some reason the “instant start” system fails, the mechanical starter is the back up, guaranteeing that the engine will start at all times.

It is well understood that is method of “instant start” cannot work with the sequential fuel injection systems that are now in use as there is no fuel left in any cylinder nor in the intake manifold after the engine is shut down.

The invention described herein:
a) changes liquid gasoline to a true gas that burns clean in the cylinder
b) showed that approximately half of the fuel was required at idling. In fact the idle adjustment in the fuel-mixing device 6 had to be set back when the module 12 was used as the engine would speed up at idle when the module 12 was added.
c) showed that a leaner mixture of fuel to air is possible.
d) showed that gases and liquid droplet as very different “state of matter” and burn differently.
e) present apparatus that is a pre intake manifold vacuum module for use with a gasoline powered 4 cycle internal combustion engine.
f) describes apparatus where a carburetor a throttle-body can be directly attached or connected to the inlet port of the vacuum module.
g) describes apparatus where the outlet port of vacuum module is directly connected to the inlet port of the engine intake manifold which in turn supplies the high vacuum inside the fuel conditioning module.
h) describes a vacuum module where gasoline is supplied to it in an atomized form by a throttle-body source.
i) illustrates a passageway that is provided by the supporting, dividing partitions that together form the passageway for the fuel-air mixture to follow to the intake manifold.
k) describes a vacuum module that can be directly attached to the intake manifold or can be connected with rigid or flexible methods.
l) shown a vacuum module that is small enough in dimension that is can be installed on the engine and or will fit into the engine compartment or any convenient space on the vehicle.
m) describes an invention that uses direct manifold vacuum and normal engine temperatures to cause a partial or total change of state of the liquid gasoline molecules to a gas.
n) describes a vacuum module with a passageway that separates the fuel-air throttle several feet from the intake manifold. Even when the throttle effective distance from the carburetor was increased to 20 feet, the throttle response remained relatively instant.
o) describes a module with a passageway inside the module that provides the heat, the time and the distance for the liquid gasoline droplets to change state from liquid to a gas.
p) describes an apparatus that causes turbulence in the flow of the fuel-air mixture to scavenge heat from the module because of a serpentine pathway coupled with the high velocity of the engine's aspiration air flow.
q) describes an apparatus that produces gasified fuel that will burn more completely than wet saturated fuel-air mixtures.
r) describes an apparatus that receives it's heat source by conduction from contact with the engine and by convention air from the exhaust manifold.
s) describes an invention where Hydrocarbon and Carbon Monoxide gas exhaust emissions are greatly reduced.
t) describes an apparatus that causes smoother engine performance because all cylinders receive exactly the same gasified fuel-air mixture from the intake manifold.
u) describes an apparatus that increases power and improves mileage.
v) describes an apparatus where an accelerating pump is not required for a carbureted system to inject extra fuel to enrich the fuel to air ratio during acceleration.
w) describes an invention that changes regular gasoline into one of the cleanest burning liquid engine fuels while retaining all it's performance and power.
x) describes an invention where throttle response is just as instant when the fuel passes several feet through the vacuum module as when a wet saturated mixing device is bolted directly to the intake manifold.
y) describes an invention that causes longer engine life because less carbon is being formed that normally becomes an abrasive factor in the engine oil.

Furthermore the invention described herein illustrates that substantially all fuel is gasified, therefore more complete combustion regardless of the RPM. Both propane and liquid natural gas (LNG) burn in cylinders as gases and burn much more completely than vaporized gasoline. The invention herein shows that gasoline along with propane and LNG can burn as true gases with virtually all CO burned up and substantially all liquid hydrocarbons used up.

It is believed that since the module 12 is placed between the throttle and the intake manifold that an extremely low pressure is developed in the module 12 as a result of the engine vacuum, which combined with the high velocity of aspiration due to the venturi effect, in the presence of heat (from under the hood or conduction from the engine) liberates the hydrogen and carbon atoms from the vaporized gasoline or hydrocarbons. Gasoline to a large part is comprised of heptane or octane. Therefore it is believed that the module as described herein provides a means where individual atoms not liquid hydrocarbon molecules, change state. Furthermore the serpentine fuel air passage inside the module 12 (so long as it is long enough for sufficient natural aspiration to take place) presents a resistance to gas flow. This resistance is believed to be necessary to cause turbulence so as to bring the fuel droplets into contact with the metal surfaces of the module 12 and change the state of the fuel droplets to a gas as described herein.

This invention presents some resistance to the fuel air flow. The resistance factor can reduce power by restricting the flow when using natural aspiration Therefore a turbo charger can be used in another embodiment of the invention so as to provide a more than adequate supply of air. Generally speaking turbo charging increases the power of engines.

Although various embodiments of the invention and of various features of the invention have been described in detail, the above description should be understood as being only exemplary in the invention. Therefore, it will be understood that various modifications of the construction and operation of the above described embodiments will be apparent to those of ordinary skill in the art. Accordingly the scope of the present invention is to be limited only by the appended claims.

We claim:

1. A module for an internal combustion engine having:
(a) an inlet communicating with a fuel-air mixing device;
(b) an outlet communicating with an intake manifold;
(c) a passageway communicating with the inlet and outlet for permitting the fuel to substantially change from a liquid to a gaseous state when mixed with the air.

2. A module as claimed in claim 1 wherein the module includes passageway lengthening means.

3. A module as claimed in claim 2 wherein the module comprises of thermally conductive material and the passageway lengthening means comprises partition means.

4. A module as claimed in claim 3 wherein the thermal conducting material is selected from the group of aluminium, steel and copper.

5. A module as claimed in claim 4 wherein the partition means comprises a plurality of substantially parallel conduits each having one end and another end.

6. A module as claimed in claim 5 wherein one end of one of the conduits defines the inlet and one end of another conduit defines the outlet.

7. A module as claimed in claim 6 wherein the other plurality of conduits have adjacent one ends and adjacent other ends communicating with one another to define the passageway.

8. A module as claimed in claim 7 wherein the plurality of conduits are disposed along a common plane.

9. A module as claimed in claim 8 further comprising pressure relief valve means.

10. A module as claimed in claim 9 including a secondary air input.

11. A fuel conditioning vacuum module for an internal combustion engine having a fuel-air mixing device and an intake manifold communicating with at least one cylinder, said module comprising:
(a) an input communicating with the fuel-air mixing device;
(b) an outlet communicating with the intake manifold;
(c) a plurality of plates disposed within the module to define a passageway between the inlet and outlet to permit the fuel from the fuel-air mixing device to change to a substantially gaseous state in the fuel-air mixture when communicating with the at least one cylinder.

12. A module as claimed in claim 11 wherein the module comprises a generally rectangular container disposed between the fuel-air mixing device and the intake manifold.

13. A module as claimed in claim 12 wherein the container comprises top and bottom and spaced sidewalls and spaced end walls.

14. A module as claimed in claim 13 wherein the plates extend between the sidewalls and from one of the top and bottom walls to present a serpentine passageway between the inlet and outlet.

15. A module as claimed in claim 14 wherein the module comprises thermally conductive material.

16. A method of changing the state of liquid fuel to a gas when the liquid fuel is introduced into a fuel-air mixing device in an internal combustion engine communicating with at least one cylinder comprising the steps of:
(a) disposing a thermally conductive module between the fuel-air mixing device and the cylinder; the module having an inlet and an outlet communicating with a passageway there between;
(b) extending the passageway through a length in the module to permit mixing of the fuel in a substantially gaseous state with the air.

17. A method as claimed in claim 16 wherein the passageway length is greater than the length between the inlet and outlet.

18. A method as claimed in claim 17 wherein the passageway is serpentine.

19. A method as claimed in claim 18 wherein the stoiciometeric ratio of air to gasoline in the gaseous state is between 14:1 and 17:1.

20. A method as claimed in claim 19 providing a secondary air valve.
